(19) United States
(12) Patent Application Publication
(10) Pub. No.: US 2018/0280248 A1
(43) Pub. Date: Oct. 4, 2018

(54) FORCE-SENSING PERCUTANEOUS GASTROSTOMY TUBE DEVICE AND METHODS THEREOF

(71) Applicant: The Research Foundation for The State University of New York, Syracuse, NY (US)

(72) Inventor: Anthony Feghali, Syracuse, NY (US)

(21) Appl. No.: 15/941,702

(22) Filed: Mar. 30, 2018

Related U.S. Application Data
(60) Provisional application No. 62/479,673, filed on Mar. 31, 2017.

(51) Int. Cl. A61J 15/00

(52) U.S. Cl. CPC A61J 15/0088; A61J 15/0015; A61J 15/0034; A61J 15/0042

(57) ABSTRACT

A percutaneous endoscopic gastronomy tube device includes an elongate tube extending between a first end and a second end. A flange is coupled to the elongate tube at the second end. A force sensor is configured to generate a signal indicative of a force applied to the flange. Systems including the percutaneous endoscopic gastronomy tube device are also disclosed.

This application claims the benefit of U.S. Provisional Patent Application Ser. No. 62/479,673, filed Mar. 31, 2017, which is hereby incorporated by reference in its entirety.

### FIELD OF THE INVENTION

The present invention relates to a gastrostomy tube device, and more specifically a force-sensing percutaneous gastrostomy tube device, systems including the device, and methods of use thereof.

### BACKGROUND OF THE INVENTION

Currently over 250,000 percutaneous gastrostomy (PEG) tubes are placed in patients per year in the United States. This number has been increasing each year. As the number of PEG tubes placed increases, so have complications from the use of the PEG tubes.

Two of the most devastating and common complications associated with the use of PEG tubes are a dislodged tube and a buried bumper. These complications occur due to excessive force from the internal bumper. The complications result due to the placement and positioning of the PEG tube in the patient.

In use the PEG tube extends from the gastric lumen of a patient through the gastric and abdominal walls to the external environment. An internal bumper at the distal, internal end of the PEG tube prevents the tube from passing through the gastric wall, and an adjustable retention ring attached to the PEG tube external to the patient and placed adjacent to the skin prevents the PEG tube from receding into the gastric lumen; together the internal bumper and retention ring hold the PEG in place.

Improper adjustment of the external retention ring on the PEG tube and movement of the retention ring relative to the internal bumper can result in excess pressure being applied by the internal bumper to the inner wall of the gastric lumen. Over time, this excess pressure results in damage to the gastric wall, such as an abscess. In severe cases, the internal bumper penetrates into the gastric wall resulting in Buried Bumper Syndrome, which causes severe problems. This complication leads to further surgery and possible severe morbidity and mortality due to a hole within the stomach.

Many studies have looked at this complication and have indicated a 30-day mortality rate of around 7.8% with a 7-day early accidental dislodgement rate as high as 4.1%. The total lifetime accidental PEG tube dislodgement rate has been reported to be about 12.8%. Many of these accidental dislodgements occur in long term care facilities such as nursing homes and rehabilitation centers. The vast majority of cases require an emergency department visit, a level 3 surgical consultation, a replacement PEG tube, and a radiographic confirmation of tube positioning, resulting in medical care costs totaling an average of $1,200 per incident. Studies have put the cost of severe complications at greater than $65,000 per patient.

There is a need for a PEG tube that will help prevent these devastating complications by informing and/or notifying the patient, physician, caretaker, and nursing staff when the PEG tube is exerting excessive pressure on the inner wall of the gastric lumen.

The present invention is directed to overcoming these and other deficiencies in the art.

### SUMMARY

One aspect of the invention relates to a percutaneous endoscopic gastronomy tube device includes an elongate tube extending between a first end and a second end. A flange is coupled to the elongate tube at the second end. A force sensor is configured to generate a signal indicative of a force applied to the flange.

Another aspect of the invention relates to a percutaneous endoscopic gastronomy system including the percutaneous endoscopic gastronomy tube device. A processing device is coupled to the force sensor. The processing device is configured to be capable of receiving the signal from the force sensor. The received signal from the force sensor is analyzed. An output signal is generated based on the analysis of the received signal.

Yet another aspect of the invention relates to a percutaneous endoscopic gastronomy system including the percutaneous endoscopic gastronomy tube device. A voltage-activated display indicator is coupled to the force sensor. The voltage-activated display indicator is configured to generate a display based on the force applied to the elongate tube or the flange. A power source is coupled to one or more of the force sensor or the voltage-activated display indicator.

The present invention provides a percutaneous endoscopic gastronomy tube device, systems utilizing the device, and methods of use thereof. The present invention advantageously resolves the medical complications caused by excessive pressure of the internal bumper of a PEG tube on the gastric wall of the patient in whom it is installed, which clinical practice has shown to be frequent in the use of PEG tubes. Specifically, the complications that are prevented by the present invention include “Buried Bumper Syndrome” and a dislodged tube. The present invention can be incorporated into various tube types including, by way of example only, gastrostomy tubes, endotracheal tubes, vascular balloons, and Foley or catheter tubes.

The percutaneous endoscopic gastronomy tube device incorporates a force sensor, such as into the internal bumper or the tube proximal to the internal bumper, so that excess pressure of the PEG tube on the gastric wall can be detected (e.g., pressure of the bumper on the gastric wall). A signal (analog or digital) from the force sensor is communicated to a receiving unit capable of processing the signal such that medical personnel and/or patients can be provided with information necessary to determine whether adjustments to the PEG tube's placement or components (e.g., retention ring) are advisable or necessary.

The devices and systems of the present invention overcome and help to prevent many of the complications that are a result of dislodged tubes that cannot be identified in a timely and effective fashion. The integrated sensor within the internal bumper will alert both the patient and medical staff when excessive pressure is applied to the gastric wall. This allows for external adjustment of the tube that will prevent the morbid complications associated with a dislodged tube or a buried bumper.

### BRIEF DESCRIPTION OF THE DRAWINGS

FIG. 1 is a perspective view of an exemplary force-sensing percutaneous endoscopic gastronomy (fsPEG) tube device of the present invention.

FIG. 2 is a cross-sectional perspective view of a portion of the fsPEG tube device shown in FIG. 1.

FIG. 3 is an end view along the axis of the tube of the bumper or flange of the exemplary fsPEG tube device shown in FIG. 1.

FIG. 4 is a perspective view of feeding port that can be operatively connected to the fsPEG tube shown in FIG. 1.

FIG. 5 is a perspective view of a fsPEG system of the present invention including the fsPEG tube shown in FIG. 1, an optional retention ring for securing the fsPEG tube in the patient slidably attached to the tube, an optional external tubing clamp for occluding the fsPEG tube through which fluids will pass, and a feeding port fluidically connected via the connector to the proximal end of the tube.

FIG. 6 shows the fsPEG system shown in FIG. 5 in use in the stomach wall of a patient.

FIG. 7 is an exemplary circuit that may be utilized in the fsPEG tube device of the present invention.

FIG. 8 is another exemplary circuit that may be utilized in the fsPEG tube device of the present invention.

FIG. 9 is yet another exemplary circuit that may be utilized in the fsPEG tube device of the present invention.

FIG. 10 is still another exemplary circuit that may be utilized in the fsPEG tube device of the present invention.

FIG. 11 is another exemplary circuit that may be utilized in the fsPEG tube device of the present invention.

FIG. 12 is a block diagram of the arrangement of the electrical components in an exemplary embodiment of the fsPEG tube of the present invention.

### DETAILED DESCRIPTION OF THE INVENTION

The present invention relates to a gastrostomy tube device, and more specifically a force-sensing percutaneous gastrostomy tube device, systems including the device, and methods of use thereof. The devices and system of the present invention advantageously overcome complications associated with the use of percutaneous gastronomy tubes.

One aspect of the invention relates to a percutaneous endoscopic gastronomy tube device includes an elongate tube extending between a first end and a second end. A flange is coupled to the elongate tube at the second end. A force sensor is configured to generate a signal indicative of a force applied to the flange.

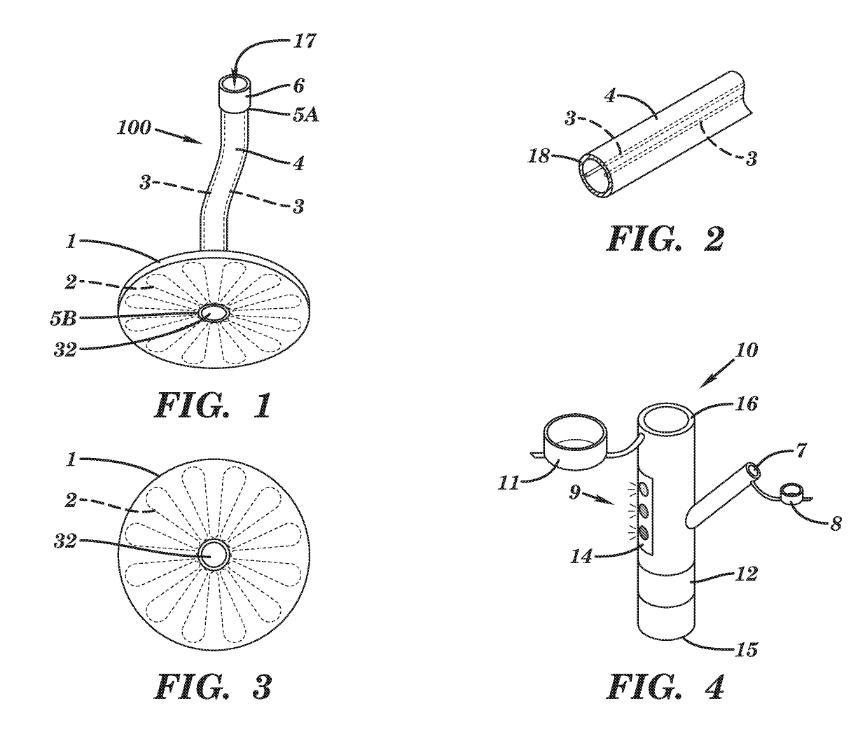

One embodiment of a force-sensing percutaneous endoscopic gastronomy (fsPEG) tube device 100 of the present invention is illustrated in FIGS. 1-3. Gastronomy tubes may also be referred to in the art as gastronomy feeding tubes or G-tubes. FIG. 1 is a perspective view of exemplary fsPEG tube device 100 that includes a bumper or flange 1, a force sensor 2, conductive wires 3, tube 4, and an optional connector 6, although fsPEG tube device 100 may include other additional elements in other combinations. The fsPEG tube device 100 of the present invention can be used in the same way as a standard PEG tube or system in patient treatment.

The force-sensing percutaneous endoscopic gastronomy (fsPEG) tube device 100 is designed to help prevent the complications normally associated with such devices as described above. By incorporating the force sensor 2 into the internal bumper or flange 1, or into the tube 4 proximal to the internal bumper or flange 1, the present invention enables medical personnel to assess the pressure being applied by the internal bumper or flange 1 to the gastric wall and take appropriate corrective action before such pressure results in a medical issue. Appropriate corrective action would generally include adjusting the device, as described below, to relieve the pressure of the internal bumper or flange 1 on the gastric wall.

One aspect of the present invention is includes the ability to monitor the fsPEG tube device 100 to determine whether an adverse event is occurring, and generating an alert, thus enabling medical personnel to respond when an adverse event is detected. For purposes of this disclosure, an adverse event is a circumstance or set of circumstances (criteria), detectable by the force sensor 2, that has been determined to be predictive of potential injury or indicative of actual injury by a PEG system to the patient.

An adverse event is one that causes, or has the potential to cause, the medical complications or injuries such as those described above. Whether an adverse event is occurring or has occurred will generally be determined by comparing the signal received from the force sensor 2, or some function of that signal (e.g., log(signal), sum(signal measured at 1 minute increments), the signal converted into a measure of force or pressure), to a threshold or criterion that has been predetermined to be indicative of an adverse event, and if the threshold has been exceeded or the criterion has been met, an adverse event is judged to be occurring or have occurred. Examples of thresholds the exceeding of which would be indicative of an adverse event are: a predetermined magnitude that the signal should never exceed (i.e., a maximum safe force or pressure); the maximum length of time during which the signal can be above a predetermined level (e.g., the signal should not exceed X: for more than Y consecutive minutes: or for more than Y total minutes during any 24 hour period); a level of cumulative signal, integrated over time, which is unsafe.

Referring again to FIGS. 1-3, tube 4 is elongate and extends between a first or proximal end 5A and a second or distal end 5B. In this example, tube 4 is a percutaneous gastronomy tube, although the present invention may be utilized with other types of types such as endotracheal tubes, vascular balloons, and Foley or catheter tubes, by way of example. In one example, the tube 4 is formed of silicon, although other materials that are soft, flexible, and inert to the body may be utilized for the tube 4. The tube can be composed of any materials suitable for use in PEG tubes. A hollow portion or lumen 17 of the tube 4 allows for nutrients and/or medicine to be introduced into the gastric cavity from an external source when the fsPEG tube device 100 is in use.

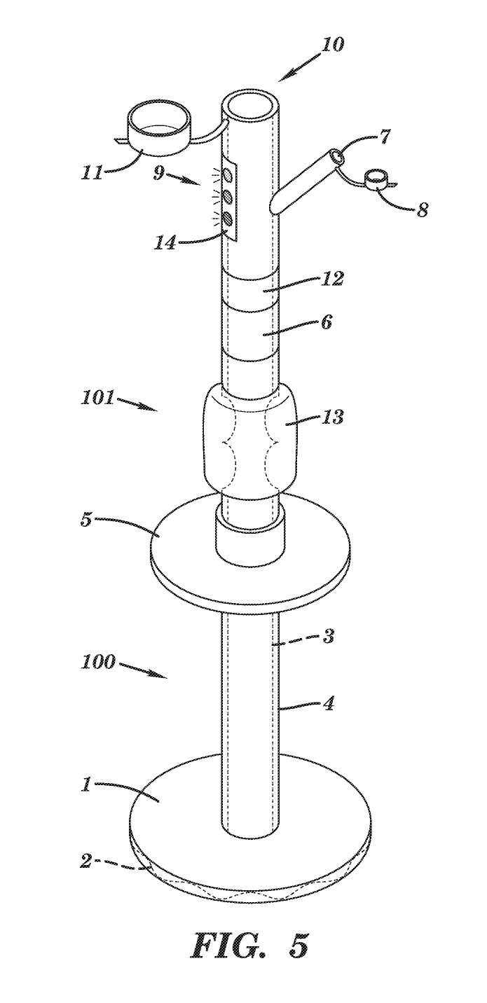

Bumper or flange 1 is affixed to tube 4 proximate distal end 5B of the tube 4. The bumper or flange 1 has an opening 32 aligned with the lumen 17 of the tube 4 to allow the passage of fluids, nutrients, and/or medicine in the tube 4, such as into the stomach during use of the fsPEG tube device 100. The opening 32 into the lumen 17 of the tube 4 is located in the center of the bumper of flange 1 in this example, but may be located in other locations. In use, the fsPEG tube 100 will pass through a patient's abdomen and stomach walls (as shown in FIG. 5), and the distal end 5B of the tube 4 and the bumper or flange 1 will be situated within the gastric lumen while the proximal end 5A of the tube 4 will be situated external to the patient.

In one example, the bumper or flange 1 integrates force sensor 2 that is capable of detecting a force applied to the bumper or flange 1. In another example, the force sensor 2 can be coupled to the tube 4 between the bumper or flange 1 and the distal end 5B of the tube 4. In yet another example, the force sensor 2 is coupled to the tube 4 proximate the distal end 5B of the tube. The bumper of flange 4 is generally made of a soft, flexible material and is convex in shape. In one example, the bumper or flange 1 is a substantially hemispherical, hollow structure. In another example, the bumper or flange 1 is a balloon capable of being inflated with the fsPEG tube device 100 is in use.

In this example, force sensor 2, is embedded in the bumper or flange 1. The force sensor 2 is configured to generate a signal indicative of a force applied to the bumper or flange 1. In this example, the force sensor 2 is a force sensing resistor, although in other examples force sensor 2 may be a pressure sensitive transducer that generates a signal indicative of or proportional to the amount of pressure applied to a flexible substrate, a strain gauge, or a load cell. The force sensor 2 is positioned and configured to register force exerted by the bumper or flange 1 on the inner wall of the gastric lumen during use. FIG. 3 shows a view of the bumper or flange 1 along the axis of the tube 4, with one exemplary configuration of the force sensor 2 (e.g., a force sensing resistor) embedded in the bumper or flange 1. The configuration of force sensor 2 shown in FIG. 3 is only one of many possible configurations for the force sensor 2.

As set forth above, in one example, the force sensor 2 is a force sensing resistor (FSR). FSRs are resistive sensors exhibiting varying resistance that responds to force applied to the sensing area. As force on the FSR is increased, this resistance is decreased. While the accuracy of FSRs can be lower than that of other pressure sensors (e.g., load cells), FSRs have significant advantages in terms of a low physical profile and cost-effectiveness (no need for bridge circuits or instrumentation amplifiers), in applications where relative or coarse absolute force measurements are acceptable. The relationship between input force and output resistance of an FSR is primarily determined by sensor shape, trace geometry, and ink formulation used in the manufacturing process, but can is also influenced by mounting and actuation.

In the simplest layout configuration (Single-Zone), the FSR will act as a two-terminal device that can essentially be treated as a variable resistor whose value is controlled by applied force. FSR construction can generally be categorized as one of two types: ShuntMode and ThruMode. Both FSR types are 2-terminal, 2-layer devices, and are interchangeable in terms of basic functionality. The present invention can apply either type of FSR as the force sensor 2.

In ShuntMode construction, the top layer of the FSR includes a solid area of a semiconductive FSR element deposited on a flexible substrate. The bottom layer is comprised of conductive traces on a flexible substrate, arranged into two sets of interdigitating fingers. When the two layers are pressed together, the semiconductive FSR element on the top layer shunts the traces on the bottom layer (hence the name ShuntMode), varying the resistance seen across the output terminals.

In ThruMode construction, a solid semiconductive FSR element is deposited on top of solid conductive top and bottom layers, which are then affixed facing one another. The solid conductor on each layer runs to a single output terminal, and any excitation current passes through one layer to the other, hence the name ThruMode.

FSRs utilized as the force sensor 2 in the present invention can be Single-Zone FSR (a single sensing element, with two terminals), FSR Discrete Array (a discrete array is simply a collection of any number of Single-Zone elements, printed together on a single substrate; the two terminals of each sensor element may be pinned out individually, or connected to a common trace at one end to reduce connector contacts), or a Matrix Array (a large quantity of sensing elements are arranged in a grid, with each sensor element located at the intersection of a row and column; rows and columns are pinned out, rather than individual sensors as in a Discrete Array). Matrix array FSRs require multiplexed scanning electronics.

FSRs used for the force sensor 2 in this example of the present invention should be designed for the ambient temperature at which it will be operating (e.g., body temperature) and the objects that will apply the force to the force sensor 2 (e.g., the stomach's inner wall). The FSR should also be sealed to protect it from the humid, acidic, and moist environment inside the stomach. Consistent actuation is a critical factor in achieving consistent FSR readings. By embedding the FSR used as the force sensor 2 in the bumper or flange 1, which is preferably made of a relatively thin elastomer, such as silicone rubber, some error from inconsistent force distribution by the stomach wall on the fsPEG bumper or flange 1 is absorbed.

A threshold circuit can be used to set the limit at which the force sensor 2 is considered “in contact” and an alert is triggered. Dielectric dot patterns can also be used for spacing the two layers apart. The frequency or spacing and height of the dots determine the amount of force needed for actuation. The closer the dots are to each other, the more force is required to activate the force sensor 2. Disc Actuators are ideally shaped to cover 80% of the FSRs sensing area. Disc-type actuators are typically made of rubber or other semi-flexible material. Dome Actuators are similar to disc actuators, but are domed or radiused. Shaping the dome can help linearize the FSR. In the present invention, the FSR utilized as the force sensor 2 will generally be mounted to curved and/or soft/conformal surface, and will be customized to provide the response necessary to determine whether an excessive or problematic force is being applied to the bumper or flange 1 of the fsPEG tube device 100.

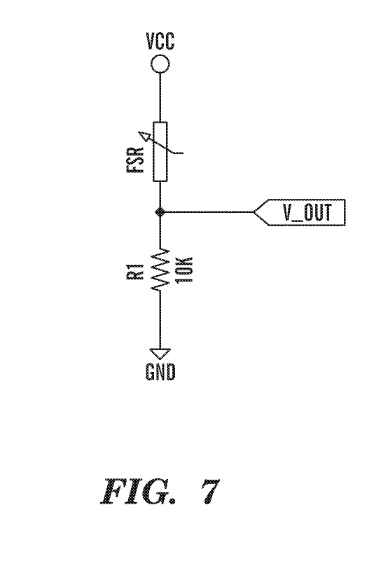

FIG. 7 illustrates a sample circuit for a voltage divider that may be used in association with the force sensor 2. In this measurement circuit, a reference resistor (R1) is placed in series with the FSR. A known supply voltage is applied, and output voltage is measured across R1. The output is given by the equation: V_{OUT}=(V_{CC}×R1)/(R1+R_{FSR}). The resistance to voltage relationship is typically non-linear. R1 can be calculated for optimal resolution over the desired measurement range, but generally speaking, a value near the midpoint of the FSR's resistance range (on a logarithmic scale) works well. In this example, the FSR has a resistance range of 1 k-100 k, so R1=10 k is a reasonable choice. In designs where coarse/relative measurements are acceptable, a simple divider will often suffice.

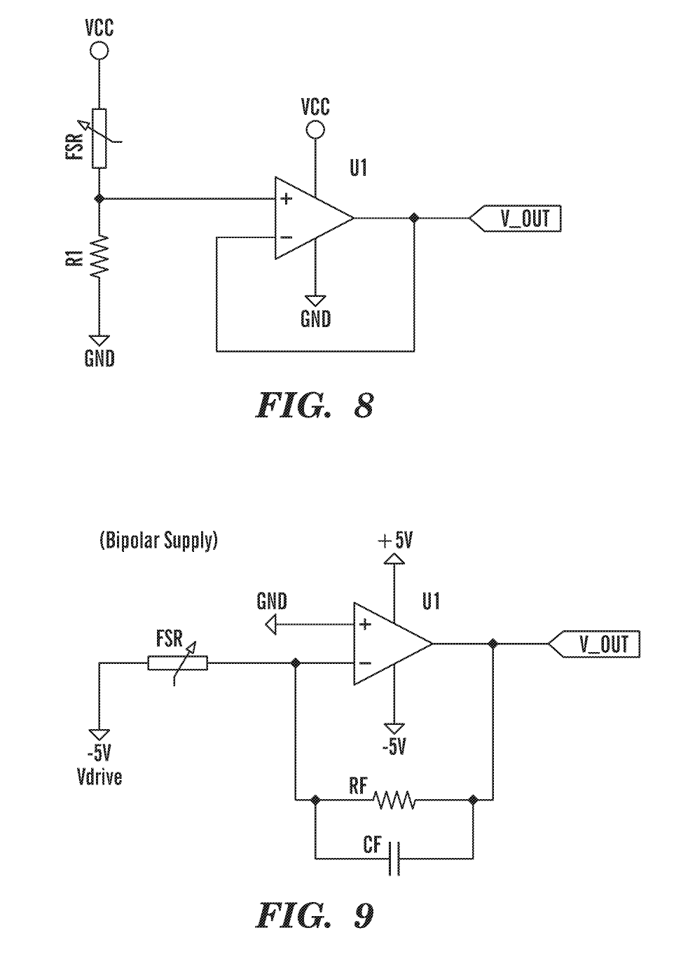

FIG. 8 shows a buffered voltage divider circuit that may be employed in association with the force sensor 2. In this variation, a unity gain buffer (aka voltage follower) follows the divider. A buffer is required when sampling circuitry input impedance is low enough to impart loading error on the divider, or the output impedance of the voltage divider is otherwise greater than specified ADC requirements. Using an Arduino, for example, although the input impedance of analog input configured pins is very high, the MCU datasheet recommends a maximum sensor output impedance of 10 k. The input presents a capacitive load, which cannot charge quickly enough through the high-impedance divider for accurate sampling. Part selection is not particularly critical, but the op-amp should at least be unity gain stable, with rail-to-rail input/output (RRIO).

FIG. 9 illustrates an I-V Converter (Transimpedance Amplifier) circuit. A current-to-voltage converter, or transimpedance amplifier, exhibits a somewhat more uniform/ideal transfer function than voltage dividers. Unlike a divider, a transimpedance amp can allow a fixed voltage to be applied across a single FSR element, regardless of other parallel FSRs/resistances. Applying ideal op-amp assumptions to the example circuit of FIG. 9, the voltage across the input terminals is zero, so V_{IN-}=0 v (virtual ground). Zero current flows in/out of the input terminals, so I_{RF}=I_{FSR}. From there, calculations are straightforward, and V_{OUT} is given by: V_{OUT}=(−V_{DRIVE}/R_{FSR})×R_{F}.

Provided that a rail-to-rail in/out op-amp is selected, the output swings from 0 v to 5 v. A feedback capacitor (C_{F}) is optionally used to limit bandwidth and maintain stability. Optimal C_{F} value calculations are omitted here as they must account for FSR resistance, op-amp GBP, and stray capacitance. For the sake of experimentation, 10 pF to 33 pF is often a good starting point. Generally, an op-amp is selected with: very low input bias current (Ib in the range of nA or pA)—JFET or CMOS inputs—Bandwidth/Slew Rate selected to meet sample rate requirements—Usually RRIO.

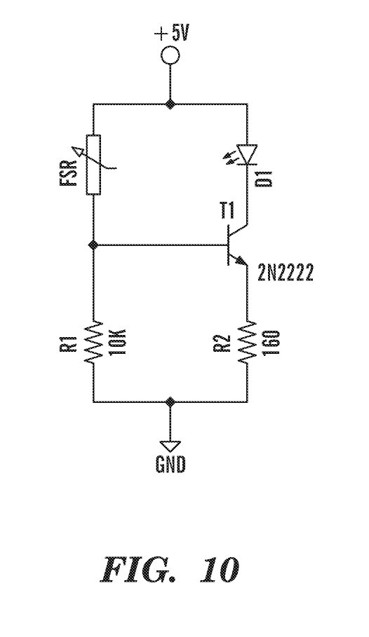

FIG. 10 shows a Force-Sensitive Load Driver (LEDs, etc.) circuit. When driving loads that require more than a couple milliamps, it may be tempting to simply place an FSR in series with the load. This is not a good idea, as most FSRs have a maximum current rating in the ballpark of 1 mA to 10 mA; exceeding this rating will damage the FSR. Instead, the FSR should be used to control an output driver, i.e. BJT or FET. FIG. 10 provides an exemplary circuit where an FSR controls base current of a BJT to drive an LED in common-emitter arrangement. The result is a force-dimmed LED flashlight, more or less. In an embodiment of the present invention, this circuit is used to dim an LED indicating that everything is okay (e.g., a green LED) or, after appropriate changes familiar to those skilled in the art of electric circuit design, to turn on an warning LED (e.g., a red LED). In this example, V_{R2}(max)=5−1.8−0=3.2 v (max) and R2=20 mA/3.2 v=160Ω (min).

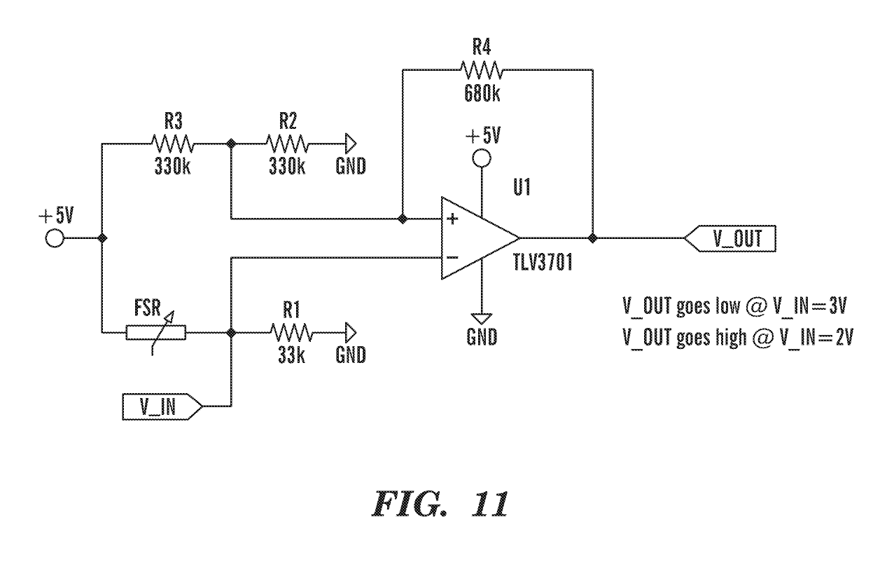

FIG. 11 shows a Force Threshold Switch with a Hysteresis circuit. FSRs used in the fsPEG tube device 100 as the force sensor 2 may be wired for threshold switching, wherein the threshold is a pressure at which an alert should be triggered. The circuit below can be used to indicate when a specified force/weight is present, with no analog to digital conversion required. Hysteresis in this circuit effectively provides hardware debouncing. If a debounced output is not desirable, R4 can be omitted. In the example circuit, R2, R3, and R4 are selected for low/high thresholds at approximately V_{TL}=2 v and V_{TH}=3 v. Skipping derivation and arbitrarily selecting 330 k for R3, R2 and R4 are calculated by: (R4/R3)=V_{TL}/(V_{TH}−V_{TL}) and R3/R2=V_{TL}/(V_{CC}−V_{TH}). R2+R3 and R4 can be replaced with two trimpots for variable threshold levels. Any number of comparators will work fine, a TLV3701 is selected in this example for push-pull output and ultra-low current (IQ). Alternatively, an op-amp can be used, but a comparator is usually preferable for faster propagation times at a lower cost.

Mounting custom FSRs to steeply curved or soft/conformal surfaces is possible in many cases, but entails higher cost due to the complexity of custom design, assembly, and testing. It is also generally acceptable to gently bend (but not crease) the FSR tail at some angle well below a ⅛″ radius. Sharper angles can be accomplished with flexible conductors. Custom forming can be performed (at manufacturing time) if acute bends are required.

In an embodiment, the FSR embedded as the force sensor 2 in the bumper or flange 1 of the fsPEG tube device 100 is provided a V_{IN} and generates a V_{OUT}. V_{OUT} is monitored on a continual basis using a processor, and if the V_{OUT} falls below a predetermined level, V_{TRIGGER}, an alert is triggered (such as turning on an indicator LED, emitting a sound or sending a text message). In an embodiment, V_{OUT} is monitored over time and if a function of V_{OUT} exceeds a predetermined threshold, an alert is generated. Various functions of V_{OUT} can be used, including, but not limited to, cumulative V_{OUT} over time (e.g., if less than X, trigger alert), cumulative V_{OUT} during a time period of specific length, average V_{OUT}, weighted-average V_{OUT}, average V_{OUT} or weighted-average V_{OUT} over a specific time period, or V_{OUT} relative to V_{TRIGGER} for a specific amount of time. V_{OUT} can be converted into a force and functions of the force measured by the FSR used as the force sensor 2 can be used to determine whether an alert should be triggered.

Referring again to FIGS. 1 and 2, as described in further detail below, the force sensor 2 is capable of communicating with an external indicator capable of indicating and/or displaying the force registered by the force sensor 2, or with an external processor capable of analyzing signals from the sensor and initiating actions, such as alerts, such as when predefined conditions are met (e.g., a threshold force has been exceeded). In one example, the force sensor 2 is electrically connected to two (or more) conductive wires 3. The conductive wires 3 are incorporated into or embedded in a wall 18 of the tube 4 as shown in FIG. 2, which is a detailed cross-sectional of the tube 4. The conductive wires 3 can be electrically insulated from the lumen 17 of the tube 4 such that the conductive wires 3 are electrically insulated from any fluids within and/or external to the tube 4. In one example, the conductive wires 3 are electrically connected to the force sensor 2 at a first end and a second device at a second end adapted to provide an electrical connection with the second device located, by way of example, external to the tube 4 near the proximal end 5A.

Optional connector 6 is connected to the proximal end 5A of tube 4. The optional connector 6 allows the tube 4, and specifically lumen 17, to be fluidically connected to a separate device, such as a feeding port (as shown in FIG. 5) or another tube during use as described below. In one example, to enable electrical connection between the force sensor 2 and an external device to the fsPEG tube, the optional connector 6 has metal electrodes which may be coupled with metal electrodes of the tube or feeding port to which the fsPEG tube device 100 is coupled. The metal electrodes at the proximal end 5A of the fsPEG tube device 100 are in turn connected to the conductive wires 3 embedded in the tube 4 which are in electrical communication with the force sensor 2 in the flange or bumper 1. The connector 6 can be designed to allow snap, click or screw in, attachment of a feeding port or second tube allowing replacement and/or cleaning of the feeding port as needed.

Another aspect of the invention relates to a percutaneous endoscopic gastronomy system including the percutaneous endoscopic gastronomy tube device. A processing device is coupled to the force sensor. The processing device is configured to be capable of receiving the signal from the force sensor. The received signal from the force sensor is analyzed. An output signal is generated based on the analysis of the received signal.

FIG. 4 shows an exemplary feeding port 10 that, by way of example, can be operatively connected to the fsPEG tube device 100 as shown in FIG. 1. In this example, the feeding port 10 includes a lumen 15. The feeding port 10 also includes a main port 16 for the introduction of food, by way of example, and a secondary port 7 for the introduction of medicine, by way of example. Both the main port 16 and the secondary port 7 are in fluid communication with the lumen 15 of the feeding port 10. Each of the main port 16 and the secondary port have a respective cap (cap 11 for the main port 16 and cap 8 for the secondary port 7). The caps 11 and 8 are for sealing the opening of the main port 16 and the secondary port 7, respectively.

FIG. 5 shows an exemplary fsPEG system 101 including the fsPEG tube device 100 coupled to the feeding port 10. The feeding port 10 is fluidically connected to the fsPEG tube device 100 via the connector 6 to the proximal end 5A of the tube 4. In another example, the feeding port is an integral (i.e., nonremovable) part of the fsPEG tube device 100. In this example, both the main port 16 and the secondary port 7 are fluidly connected to the lumen 15 of the feeding port 10, which is fluidly connected to the lumen 17 of the tube 4 of the fsPEG tube device 100 to deliver various fluids or medications to the patient's stomach during use as described below.

As shown in FIG. 5, the fsPEG system 101 also includes an optional retention ring 5 for securing the fsPEG tube device 100 in the patient. The optional retention ring 5 is slidably attached to the tube 4. The retention ring 5 includes a locking mechanism configured to secure the retention ring 5 in place along the tube 4 with sufficient strength to prevent the retention ring from sliding along the tube 4 when the locking mechanism is engaged. An optional external tubing clamp 13 is located on the tube 4 for occluding the fsPEG tube device 100 through which fluids will pass.

Referring now to FIGS. 4 and 5, the feeding port 10 further includes a receiving unit or processing device 14, an alert indicator 9, and a power source 12, although the feeding port 10 may include other device and/or components in other combinations. In another example, the receiving unit 14, the alert indicator 9, and/or the power source may be located in an enclosure (e.g., a housing) separate from the fsPEG tube device 100 and the feeding port 10. The separate enclosure or housing may be electrically and/or wirelessly connected to the force sensor 2.

In other examples, the feeding port 10 is a standard feeding port for a standard PEG tube (i.e., it does not incorporate a power source, electrodes, a receiving unit, or an alert indicator). In one example, the retention ring 5 may incorporate the power source 12, electrodes, the receiving unit 14, and the alert indicator 9, and when positioned on the tube 4 is electrically connected to the force sensor 2 in the fsPEG tube device 100.

In another example, one or more of the alert indicator 9, the power source 12, and the receiving device 14 are incorporated into a separate component which can be integral to the fsPEG tube device 100 or removably attached thereto, and is capable of being connected electrically or wirelessly to the force sensor 2 in the fsPEG tube device 100. In yet another example, the alert indicator 9, the power source 12, and receiving unit 14 may be incorporated into the optional connector 6 which, in one embodiment, is electrically connected to the force sensor 2 via the conductive wires 3 embedded in the wall 18 of the tube 4. In this embodiment, the optional connector 6 serves as both a housing for the power source 12, alert indicator 9, and the receiving unit 14 (or in another embodiment, just the power source 12 and the receiving unit 14) and as a point of connection for the separate feeding port 10.

Referring again to FIGS. 4 and 5, in this example, the feeding port 10 is coupled to the fsPEG tube device 100 such that the receiving unit 14 is electrically connected via the embedded conductive wires 3 in the tube 4 to the force sensor 2 and the lumen 15 of the main port 16 of the feeding port 10 is fluidically connected to the lumen 17 of the fsPEG tube device 100 at the proximal end 5A. In another example, a wireless transmitter may be incorporated in the tube 4 or the flange or bumper 1 and coupled to the force sensor 2 to allow for wireless communication between the force sensor 2 and the receiving unit 14.

The receiving unit 14 is capable of receiving an electrical signal from the force sensor 2 and analyzing the signal to determine whether an alert is to be generated. The receiving unit 14 is further configured to generate an output signal based on the analysis of the received signal from the force sensor 2.

The receiving unit 14 is a device capable of receiving an input (e.g., electrical or wireless signals) from the force sensor 2 in the fsPEG tube device 100 and processing such input, and generating an output (e.g., a separate electrical or wireless signal). In an embodiment where such processing indicates that certain predetermined conditions are satisfied, such output may cause, directly or indirectly, an alert to be generated by the alert indicator 9.

The receiving unit 14 may comprise one of an application specific integrated circuit (ASIC) and/or a general purpose microprocessor. The processing may involve a software algorithm in temporary or permanent memory on the receiving unit 14 such as, for example, ROM in an ASIC or RAM in a microprocessor. The receiving unit 14 may be capable of generating multiple outputs based on the input from the force sensor 2, each of which may cause a different alert, such as, for example, a first output causing a first alert indicating that the pressure level on the bumper or flange 1 is safe and/or that the force sensor 2 is working properly, a second output which causes a second alert indicating that the pressure level is moderate, and a third output which causes a third alert indicating that the pressure level is dangerous and/or that the force sensor 2 is not working properly, and each alert caused may be of multiple types (e.g., both visual and audible).

In one example, the receiving unit 14 comprises an electrical circuit including various components including, but not limited to, resistors, capacitors, switches, amplifiers, diodes, transducer, transistors, and integrated circuits, whereby the components are arranged by one skilled in the art to accomplish generating an output indicative of the state of the pressure on the gastric lumen wall or indicative that a predetermined input signal or signals or patterns of input signal or signals has been received from the force sensor 2.

The feeding port 10 also includes the alert indicator 9 that is triggered during an alert based on the signal from the force sensor 2. The alert indicator 9 is a device capable of generating a visual, audible, tactile, or other signal (an alert) detectable by patients or medical personnel. In an embodiment, the alert indicator 9 includes a three-color LED system and a sound generator. In one example, the alert indicator 9 is a voltage-activated display indicator that is coupled to the force sensor 2 and configured to generate a display based on the force applied to the elongate tube 4 or the flange 1.

In another embodiment, the alert indicator 9 is an existing alert device or system, such as, for example, a Vocera Communication System and/or Badges, or a installed communication system within a hospital, by way of example. In this embodiment, the output from the receiving unit 14 may be adapted to the protocols of the existing alert device or system, and/or the output from the receiving unit 14 may be further processed by the existing alert device or system (such as to determine if intervention is advised based on the signal from the force sensor 2). The separate alert device or system used as the alert indicator 9 in this example may receive an alert from the receiving unit 14, such as a code indicating that the fsPEG tube device 100 is exerting excessive force, and may further process the alert, such as to determine which medical personnel should be alerted and then send an alert to those personnel. The separate alert device or system may receive amplified and transmitted signals from the force sensor 2 and process and/or analyze the received signals as described below to determine whether an alert, and what kind, should be generated. Signals from the receiving unit 14 may be transmitted to the alert indicator 9 via conductive wires or a wireless connection, including via a transponder.

By way of example, the alert indicator 9 may include red, yellow, and green LED indicators. In this example, illumination of the red LED indicates excessive pressure on the flange or bumper 1, illumination of the yellow LED indicates moderate pressure on the flange or bumper 1, and illumination of the green LED indicates no pressure on the flange or bumper 1. In an embodiment, if the measured force is less than the threshold for triggering an alert, an OK signal is generated, such as an illuminated green LED. An alert indicating excessive force can be an illuminated and/or blinking red LED and/or an audible signal. A yellow LED can be illuminated to indicate acceptable levels of force on the bumper (i.e., under the threshold for triggering an alert), but more than a lower predetermined threshold indicating an “OK” level of force. An audible alert may be generated if there is excessive pressure on the flange or bumper 1 for more than a predetermined amount of time. The criterion or threshold used to determine whether an adverse event is occurring or has occurred may be stored in a memory on the receiving device 14, or may be hard-wired into the processor or receiving device 14.

Other examples of alerts that may be provided by the alert indicator 9 are sounds, lights (flashing or steady), spoken or written messages, vibrations, and/or alphanumeric symbols (such as numbers indicating the momentary, average or cumulative pressure registered by the force sensor 2). In yet another example, the alert indicator 9 may incorporate one or more of the following, in any combination: a digital display for displaying the force on the flange or bumper 1 in some unit of force (e.g., psi), one or more lights, one or more acoustic signal generators, or a mechanical or electric vibrator. The alert indicator 9 may also include a wireless transmitter (such as, for example, a cellular, Bluetooth, ZigBee or WiFi transmitter) for sending a wireless alert to medical personnel directly or via a transponder to a compatible receiver carried by medical personnel such as a Vocera Communication Badge, by way of example.

In this example, power source 12 is a battery electrically connected via the conductive wires 3 in the tube 4 to the force sensor 2. Power source 12 is also coupled to the receiving unit 14. In an embodiment, the power source 12 provides power to force sensor 2, the receiving unit 14, and the alert indicator 9. In another embodiment, the power source 12 provides power only to the receiving unit 14 and the alert indicator 9.

The power source 12 can be a battery integrated into the fsPEG tube device 100 or into the feeding port 10 or incorporated into the external receiving unit 14 or be separate and in electrical communication with both as well as the force sensor 2. Alternately, the force sensor 2, the receiving unit 12, and the alert indicator 9 can, individually or in any combination, have separate power sources. Alternately, power can be supplied from an outlet, optionally via a transformer unit to adjust the current and voltage to desired levels. If the power source 12 is a battery incorporated into the feeding port 10, the power source 12 can easily be changed out as needed without disturbing the fsPEG tube device 100.

In an embodiment, the power source 12 is electrically connected to the force sensor 2 and a voltage- or current-actuated switch is electrically connected to the force sensor 2 such that it will close (or open) when the resistance in the force sensor 2, which is a force sensing resistor in this example, drops below a certain threshold indicating excessive force. The switch is situated between the power source 12 and a signal generator such that when the voltage-actuated switch closes (or opens), power is supplied to the signal generator which then generates a signal (e.g., audible, wireless, optical, tactile).

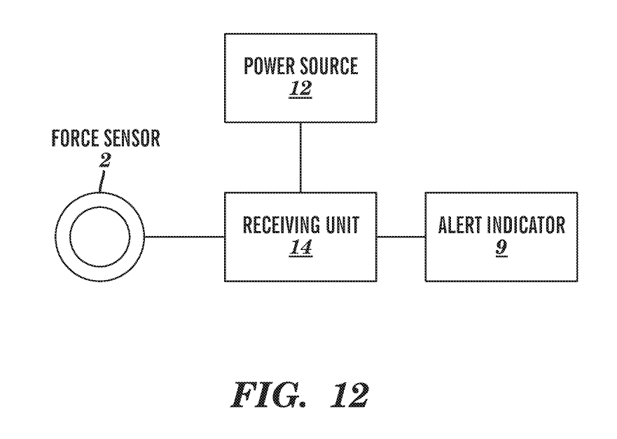

The block diagram in FIG. 12 shows an example of the connection of the principal electrical components of the fsPEG system 101. In this example, the power source 12 is in electrical communication with the receiving unit 14, which is in electrical communication with the force sensor 2 and the alert indicator 9. The power source 12 provides power to all three devices, i.e., the receiving unit 14, the force sensor 2, and the alert indicator 9 either directly or via the receiving unit 14. The number of electrical connections (e.g., wires) between these elements may be varied based on the type of force sensor 2 used, how the signal from the force sensor 2 is processed by the receiving unit 14, and the type of the alert indicator 9 used. In alternative examples, one or more of the receiving unit 14, the force sensor 2, and the alert indicator 9 may have the own source of power, such as an individual battery. In one example, force sensor 2 may have a power source electrically coupled thereto that is incorporated into the tube 4 or the bumper or flange 1.

In another embodiment, each of the receiving unit 14, the force sensor 2, and the alert indicator 9 are connected via wireless connections. In this example, the fsPEG system 101 incorporates a wireless transmitter operatively connected to the force sensor 2 and capable of wireless communication with a wireless receiver operatively connected to or within the receiving unit 14. The receiving unit 14 is operatively connected to or incorporates a wireless transmitter capable of wireless communication with a wireless transmitter operatively connected to or incorporated into the alert unit 9. In this embodiment, the receiving unit 14 receives its input from the force sensor 2 wirelessly and the receiving unit 14 sends its output to the alert indicator 9 wirelessly. Wireless transmission between any of the components of the present invention may be accomplished using any appropriate frequency and encoding, such as, for example, Bluetooth, WiFi, Zigbee, or one of the cellular wireless channels (e.g., 3G, 4G).

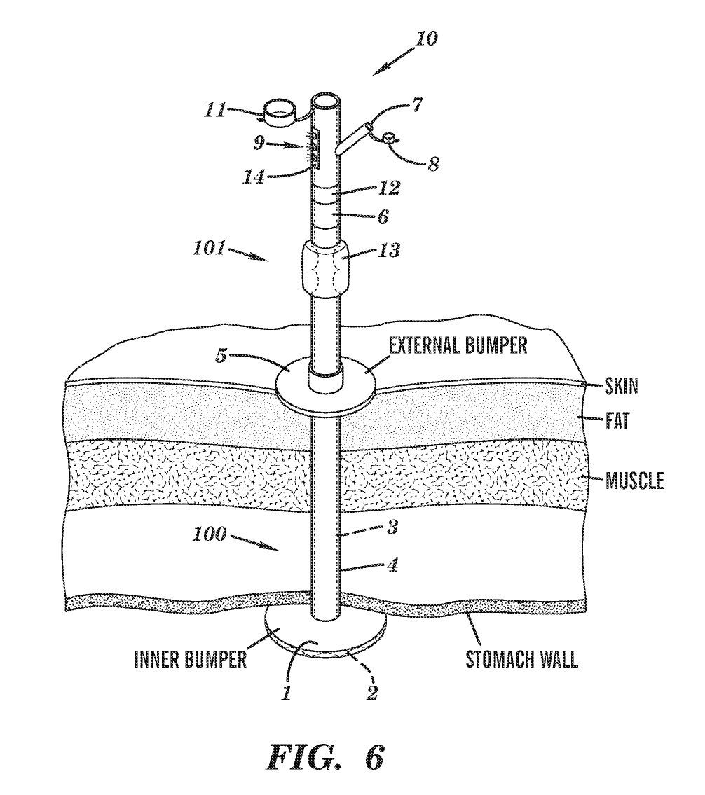

Referring now to FIGS. 1-6 an exemplary operation of the fsPEG system 101 will now be described. FIG. 6 shows the fsPEG system 101 including the fsPEG tube device 100 in use in a patient. The internal bumper or flange 1 is located against the inside wall of the gastric lumen and the retention ring 5 is located adjacent to the skin of the patient, with a portion of the fsPEG tube device 100 between them, passing through a surgically created opening in the patient's abdominal wall (skin, fat, muscle) and gastric (stomach) wall.

When pressure is applied on the gastric lumen by the bumper or flange 1 incorporating the force sensor 2, such as a force sensing resistor by way of example, the pressure is transduced by the force sensor 2 into an electrical signal that is, in the embodiment shown, transmitted via the conductive wires 3 embedded in the wall 18 to the receiving device 14, also electrically connected to the conductive wires 3, external to the body.

The electrical signal from the force sensor 2 is input to and is processed by the receiving unit 14. The processing performed by the receiving unit 14 may involve analyzing the signal from the force sensor 2 and, if certain predetermined criteria are met, generating an output. The predetermined criteria may be stored in a memory associated with the receiving unit 14. In an embodiment, the output generated by the receiving unit 14 is transmitted to the alert indicator 9 which causes the alert indicator 9 to generate an alert (the alert can be both visual and auditory, by way of example, as described in detail above).

In another embodiment, the processing may involve transmitting the electrical signal received from the force sensor 2 unchanged to the alert indicator, or processing the electrical signal from the force sensor 2 to condense or transform the signal and transmitting the condensed or transformed electrical signal to the alert indicator 9. In an embodiment, the output from the receiving unit 14 is further processed by the alert indicator 9 to determine whether to generate an alert and/or the appropriate alert to generate, such as by a microprocessor incorporated into the alert indicator 9 operating in accordance with a software algorithm in permanent or temporary memory associated with the alert indicator 9.

Processing of the signals from the force sensor 2 may further involve amplifying and then transmitting the amplified signals. Processing the signals from the force sensor 2 may involve analyzing the signals, generating an output signal, and transmitting the output signal. Analyzing the signals from the force sensor 2 may involve determining the measured force or pressure indicated by those signals received from force sensor 2 and comparing the measured force to a predetermined excessive force trigger threshold, optionally stored in a memory (e.g., RAM, ROM) or integrated into circuitry (e.g., neural network) on the receiving device 14 stored in a memory, and if the measured force exceeds the predetermined threshold, generating a signal indicating that the measured force is excessive.

The analyzing or processing may involve comparing the signal from the force sensor 2 to a predetermined criterion or set of criteria, stored in memory or hard-wired into the receiving device 14, which are indicative of an adverse event or potentially harmful situation; when the analyzing indicates that the criteria are met, an alert may be generated.

The analysis may involve summing the signal from the force sensor 2 (or equivalent force) over time and triggering an alert when the average or cumulative force over time exceeds a predetermined threshold. In an embodiment, the processing may involve tripping of a switch to cause a separate output signal to be generated to the alert indicator 9, such as when the signal from the force sensor 2 exceeds or is less than a predetermined threshold. In an embodiment where the receiving unit 14 is one of an application specific integrated circuit and a general purpose microprocessor, the analyzing of the input signal from the force sensor 2 is done by whichever is utilized in accordance with a software algorithm incorporated into the circuitry (e.g., of an ASIC) or stored in memory (e.g., on chip ROM or RAM of a microprocessor).

The receiving device 14 is capable of analyzing or processing the transduced signal sufficiently to determine whether to trigger an alert, such as when the pressure sensed exceeds a certain magnitude, or under other predetermined circumstances. In an embodiment, the alert indicator 9 is capable of analyzing or processing an output received from the receiving unit 14 to determine whether to trigger an alert. In an embodiment, whenever the force applied to the bumper or flange 1 exceeds a predetermined trigger level, an alert is triggered. In another embodiment, the force applied to the bumper or flange 1 is integrated over time and an alert is triggered when the cumulative applied force exceeds some predetermined level within a specified time period. In yet another embodiment, the number of times the force applied to the bumper or flange 1 exceeds a predetermined level is counted, and if the count exceeds a predetermined number, or a predetermined number within a predetermined period of time, an alert is triggered.

Once an alert has been generated (triggered), a healthcare provider or the patient can reduce the pressure of the internal bumper or flange 1 on the wall of the gastric lumen by adjusting the retention ring 5 to be further towards the proximal end 5A of the fsPEG tube device 100.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A percutaneous endoscopic gastronomy tube device comprising:
an elongate tube extending between a first end and a second end;
a flange coupled to the elongate tube at the second end; and
a force sensor configured to generate a signal indicative of a force applied to the flange.

2. The percutaneous endoscopic gastronomy tube device of claim 1, wherein the force sensor comprises one of a force sensing resistor or a pressure sensitive transducer

3. The percutaneous endoscopic gastronomy tube device of claim 1, wherein the force sensor is: (1) integrated into the flange, (2) coupled to the elongate tube between the flange and the second end of the elongate tube, or (3) coupled to the elongate tube proximate the second end of the elongate tube.

4. The percutaneous endoscopic gastronomy tube device of claim 1 further comprising a power source incorporated into one of the elongate tube or the flange and electrically coupled to the force sensor.

5. The percutaneous endoscopic gastronomy tube device of claim 1 further comprising a wireless transmitter incorporated into one of the elongate tube or the flange and coupled to the force sensor.

6. The percutaneous endoscopic gastronomy tube device as set forth in claim 1, wherein the flange comprises a substantially hemispherical, hollow structure or a balloon capable of being inflated when the percutaneous endoscopic gastronomy tube device is in use.

7. The percutaneous endoscopic gastronomy tube device as set forth in claim 1, wherein the first end of the elongate tube is configured to be coupled to a feeding port.

8. The percutaneous endoscopic gastronomy tube device as set forth in claim 1 further comprising:
one or more wires electrically connected to the force sensor, the one or more wires having a first end electrically attached to the force sensor and a second end adapted to form an electrical connection with a second device located external to the elongate tube near the first end.

9. The percutaneous endoscopic gastronomy tube device as set forth in claim 8, wherein the one or more wires are incorporated into a wall of the elongate tube and are electrically insulated from a lumen of the elongate tube.

10. A percutaneous endoscopic gastronomy system comprising:
the percutaneous endoscopic gastronomy tube device as set forth in claim 1; and
a processing device coupled to the force sensor and configured to be capable of:
receiving the signal from the force sensor;
analyzing the received signal from the force sensor; and
generating an output signal based on the analysis of the received signal.

11. The percutaneous endoscopic gastronomy system of claim 10, wherein the output signal indicates a force sensed by the force sensor.

12. The percutaneous endoscopic gastronomy system of claim 10, wherein the analyzing the received signal from the force sensor comprises determining when an adverse event has occurred.

13. The percutaneous endoscopic gastronomy system of claim 12 further comprising a memory coupled to the processing device, wherein the memory stores at least one criterion indicative of the adverse event, wherein the adverse event is determined to have occurred when the analyzing the received signal indicates that the at least one criterion has been met.

14. The percutaneous endoscopic gastronomy system of claim 10 further comprising:
a display indicator operatively coupled to the processing device, wherein the generated output signal provides a first display on the display indicator when the received signal equals or exceeds a predetermined force threshold.

15. The percutaneous endoscopic gastronomy system of claim 14 further comprising:
a power source coupled to one or more of the processing device, the force sensor, or the display indicator.

16. The percutaneous endoscopic gastronomy system of claim 15 further comprising a feeding port configured to be coupled to the first end of the elongate tube, wherein one or more of the processing device, the power source, or the display indicator are incorporated into the feeding port.

17. The percutaneous endoscopic gastronomy system of claim 15 further comprising a retention ring adapted to be slidably attached to the elongate tube, wherein the retention ring comprising a locking mechanism configured to secure the retention ring in place along the elongate tube with sufficient strength to prevent the retention ring from sliding along the elongate tube when the locking mechanism is engaged.

18. The percutaneous endoscopic gastronomy system of claim 17, wherein one or more of the processing device, the power source, or the display indicator are incorporated into the retention ring.

19. A percutaneous endoscopic gastronomy system comprising:
the percutaneous endoscopic gastronomy tube device as set forth in claim 1;
a voltage-activated display indicator coupled to the force sensor configured to generate a display based on the force applied to the elongate tube or the flange; and
a power source coupled to one or more of the force sensor or the voltage-activated display indicator.

20. The percutaneous endoscopic gastronomy system of claim 19 further comprising a feeding port configured to be coupled to the first end of the elongate tube, wherein one or more of the power source or the voltage-activated display indicator are incorporated within the feeding port.
